(19) United States
(12) Patent Application Publication
(10) Pub. No.: US 2022/0216655 A1
(43) Pub. Date: Jul. 7, 2022

(54) CONNECTOR

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Hisao Hattori, Yokkaichi-shi, Mie (JP); Koki Uchida, Yokkaichi-shi, Mie (JP)

(21) Appl. No.: 17/610,524

(22) PCT Filed: Apr. 23, 2020
(86) PCT No.: PCT/JP2020/017457

§ 371 Date: Nov. 11, 2021

(30) Foreign Application Priority Data
May 14, 2019 (JP) 2019-091130

(51) Int. Cl. H01R 13/66; H02J 7/00; H02J 9/06

(52) U.S. Cl. CPC H01R 13/6675; H02J 7/0063; H01R 13/6272; H02J 9/06; H02J 7/0068

(57) ABSTRACT

A connector is realized that can simplify an electrical connection and a physical connection between a connector-related component such as a housing or a wiring part, and a power storage element. A connector includes a housing, a wiring part, and a power storage element. The power storage element is attached to the housing while being held by the housing. The power storage element is configured to be charged with power supplied via the wiring part, and discharge via the wiring part.

### CROSS-REFERENCE TO RELATED APPLICATIONS

This application is the U.S. national stage of PCT/JP2020/017457 filed on Apr. 23, 2020, which claims priority of Japanese Patent Application No. JP 2019-091130 filed on May 14, 2019, the contents of which are incorporated herein.

### TECHNICAL FIELD

The present disclosure relates to a connector.

### BACKGROUND ART

Loads for vehicles such as Shift-by-Wire (SBW) and Steering-by-Wire (StrBW) need to operate even in the event of a power supply failure, and thus a configuration for supplying electric power to the loads in the event of a power supply failure is required. One technique of this type is a backup device for vehicles disclosed in JP2018-13136A. This backup device is configured to be able to supply backup power to a shift-by-wire control system.

Meanwhile, if a power storage element is provided for use as a backup power supply, it is desirable to further simplify the electrical connection and physical connection between the power storage element and other components. For example, in a configuration in which a power storage element is separately provided as an isolated structure, there is concern that an electrically conducting path from the power storage element to a load is long, and a specific structure for holding the power storage element may increase the number of components and the size of a connector.

Therefore, the present disclosure provides a connector that can simplify the electrical connection and physical connection between a connector-related component such as a housing or a wiring part and a power storage element.

### SUMMARY

According to the present disclosure, a connector includes: a housing; a wiring part that includes at least one wire and at least one terminal, one end of the wiring part being held by the housing; and a power storage element attached to the housing while being held by the housing, wherein the power storage element is configured to be charged with power supplied via the wiring part, and discharge via the wiring part.

### ADVANTAGEOUS EFFECTS OF INVENTION

According to the present disclosure, it is possible to realize a connector that can simplify an electrical connection and a physical connection between a connector-related component such as a housing or a wiring part and a power storage element.

### BRIEF DESCRIPTION OF DRAWINGS

FIG. 1 is a block diagram schematically illustrating a configuration of a vehicular power supply system in which a connector according to Embodiment 1 is used.

FIG. 2 is a perspective view illustrating a state in which the connector of Embodiment 1 is not connected to a connection-receiving part.

FIG. 3 is a perspective view illustrating a state in which the connector of Embodiment 1 is connected to the connection-receiving part.

FIG. 4 is a block diagram schematically illustrating a configuration of a vehicular power supply system in which a connector according to Embodiment 2 is used.

FIG. 5 is a perspective view schematically illustrating the connector according to Embodiment 2.

First, embodiments of the present disclosure will be listed and described.

A connector according to the present disclosure can have a configuration in which it includes: a housing; a wiring part that includes at least one wire and at least one terminal, one end of the wiring part being held by the housing; and a power storage element attached to the housing while being held by the housing. Also, the power storage element may be configured to be charged with power supplied via the wiring part, and discharge via the wiring part.

This connector can have a configuration in which the housing and the power storage element are formed as one piece in a manner such that the power storage element is held by the housing, and thus it is possible to omit a structure dedicated to holding the power storage element, and simplify a physical connection between a connector-related component such as the housing or the wiring part, and the power storage element. Moreover, the power storage element held by the housing can perform charging and discharging via the wiring part incorporated in the housing, and thus it is possible to omit the wiring extending from the power storage element to the connector. Accordingly, it is also possible to simplify an electrical connection between the connector-related component and the power storage element.

The connector according to the present disclosure may include: a discharge circuit configured to perform a discharge operation of allowing the power storage element to discharge; and the control circuit configured to controls the discharge operation of the discharge circuit.

With this configuration, it is possible to simplify not only the physical connection and the electrical connection between the connector-related component and the power storage element, but also a physical connection for holding the discharge circuit and the control circuit and an electrical connection between these circuits, the connector-related component, and the power storage element.

In the connector of the present disclosure, at least part of the wire or the terminal of the wiring part may be configured as a power supply path to a load to be backed up. The power storage element may be configured to be able to discharge to the load via this power supply path.

With this configuration, it is possible to realize a configuration in which the power storage element can be used as a backup power supply with simplified electrical connection and physical connection. Specifically, wiring or the like connected to the wire or the terminal that serves as a power supply path extending from the power storage element to the load can be omitted or simplified.

Also, if the power storage element is formed as one piece with the connector, the power storage element can be a general-purpose backup power supply that can cover various types of loads.

The connector of the present disclosure may have a configuration in which the housing includes the plurality of connection parts, and the plurality of connection parts are configured to be detachably connected respectively to a plurality of connection-receiving parts that constitute power paths to a plurality of loads. The power storage element may be configured to discharge to each of the loads via a wiring part provided on the corresponding connection part.

With this configuration, it is possible to simplify all of the configurations (such as the wiring) provided in the range from the power storage element to the power paths (power paths through which power is supplied to the loads), and thus the effect of simplifying the electrical connection and the physical connection can be further improved.

In the connector of the present disclosure, the wiring part may include at least one wire whose end on one side is held by the housing and that is drawn out from the housing. The power storage element may be fixed to an outer surface portion or an inner surface portion of the housing, and the power storage element, the housing, and the wire may be formed as one piece. The housing may be capable of being detachably attached to a connection-receiving part that constitutes a power path located on the load side relative to the housing.

With this configuration, it is possible to remove the connector in which the power storage element, the housing, and the wire are formed as one piece from the configuration on the load side from the counterpart connector, which is advantageous in terms of maintenance and the like. For example, if a part on the load side is broken and is to be replaced for example, the connector including the power storage element does not need to be replaced.

### Embodiment 1

### Overview of Power Supply System that Uses Connector

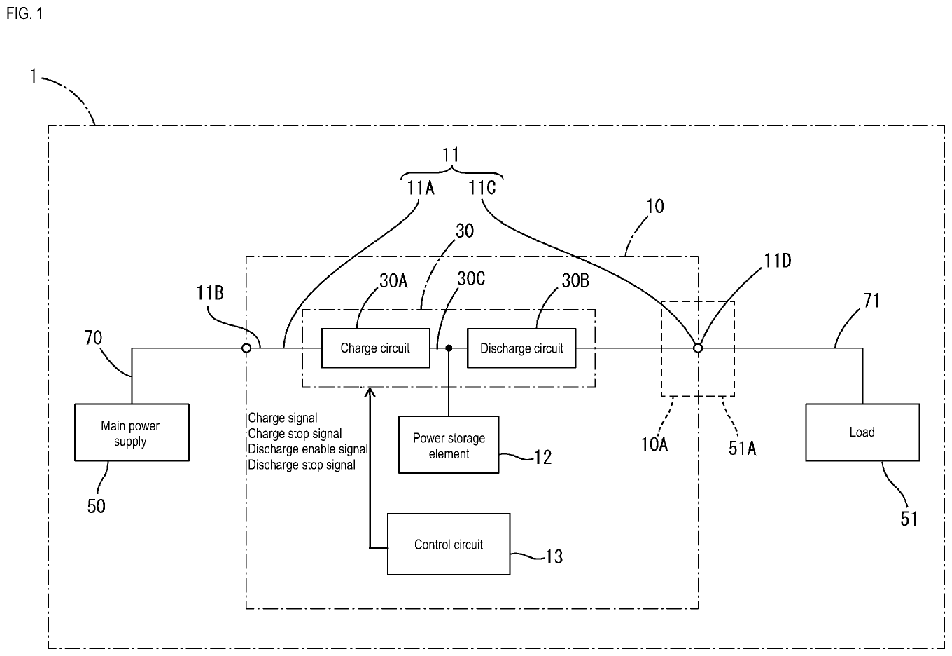

A connector 10 according to Embodiment 1 is used in a vehicular power supply system 1 (hereinafter referred to also as “power supply system 1”) shown in FIG. 1, for example. The power supply system 1 is configured to supply electric power from a main power supply 50 to a load 51 to be backed up (hereinafter, also referred to simply as “load 51”) via wires 11A during regular operation, and supply electric power from a power storage element 12 provided on the connector 10 to the load 51 via a charge and discharge circuit unit 30 in the event of a failure of the main power supply 50. Note that in FIG. 1, a path (main power path) through which power is supplied from the main power supply 50 to the load 51 during regular operation without the intermediary of the charge and discharge circuit unit 30 is omitted.

The main power supply 50 is configured as a well-known in-vehicle battery such as, for example, a lead battery. A high-potential side terminal of the main power supply 50 is connected to an input path 70, and an output voltage from the main power supply 50 is applied to the input path 70. The input path 70 is electrically connected to a power path wire 11B, which constitutes a wiring part 11 of the connector 10, and is configured to be able to supply power from the main power supply 50 to the power path wire 11B. The power path wire 11B constitutes a portion of the plurality of wires 11A, which constitute the wiring part 11, and serves as a power supply path to the load 51.

The load 51 is configured as a well-known in-vehicle electric component, and an appropriate example of the load 51 is an electric component that needs to be supplied with power even in the event that one of power supplies has failed, such as an ECU (Electronic Control Unit) or an actuator in a shift-by-wire system or a steering-by-wire system. A power path 71, which is a path through which power is supplied from the main power supply 50 or the power storage element 12, is electrically connected to the load 51. The power path 71 includes a connection-receiving part 51A to and from which a connection part 10A of the connector 10 can be attached and detached. During regular operation, the load 51 operates on the basis of power supplied from the main power supply 50, and in an abnormal case (such as when the main power supply 50 has failed), the load 51 operates on the basis of power supplied from the power storage element 12.

### Overall Configuration of Connector

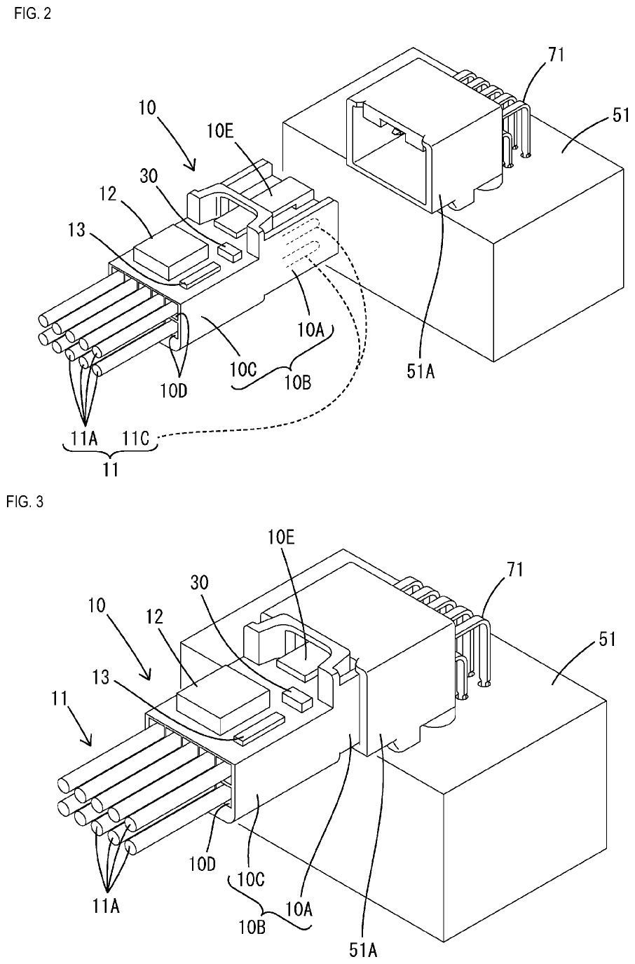

As shown in FIGS. 1 and 2, the connector 10 includes a housing 10B, the wiring part 11, the power storage element 12, and a control circuit 13. The housing 10B includes a mounting part 10C and the connection part 10A.

The housing 10B is made of a synthetic resin, and has a substantially cuboid shape elongated in one direction. A portion of the housing 10B on one side in the longitudinal direction serves as the mounting part 10C to which the power storage element 12, the control circuit 13, and the like are mounted. The mounting part 10C has a plurality of insertion holes 10D. A portion of the housing 10B on the other side in the longitudinal direction serves as the connection part 10A that is to be connected to the connection-receiving part 51A. The connection part 10A has, on an upper end surface thereof (“upper” and “lower” refer to the upper side and lower side in FIG. 1), a lock part 10E that is to be locked to a lock-receiving part (not shown) of the connection-receiving part 51A.

The wiring part 11 includes a plurality of wires 11A and a plurality of terminals 11C. In FIG. 2, only some of the terminals 11C are shown as examples. A terminal fitting (not shown) is connected to an end of each wire 11A on one side. The terminal fitting connected to one end side of each wire 11A is inserted into the corresponding insertion hole 10D of the mounting part 10C of the housing 10B, and is held by the housing 10B. That is to say, each of the wires 11A takes on a state in which one end side thereof is held by the housing 10B and the other end side is drawn out from the housing 10B. Some of the wires 11A of the wiring part 11 serve as the power path wires 11B, and are electrically connected to the input path 70 connected to the high-potential side terminal of the main power supply 50 (see FIG. 1).

The power storage element 12 is constituted by a well-known power storage means such as a solid-state battery, a lithium-ion capacitor, or a lithium-ion battery, for example. The power storage element 12 is electrically connected to a charge and discharge path 30C of the charge and discharge circuit unit 30, which includes a charge circuit 30A and a discharge circuit 30B, and is configured to perform charge and discharge operations with the charge and discharge circuit unit 30. In the connector 10 shown in FIG. 2, the outer surface portion of the housing 10B constitutes an electric board. Specifically, wiring is formed on the outer peripheral surface (outer wall surface) of the mounting part 10C of the housing 10B, and the power storage element 12 is attached to the housing 10B so that a terminal of the power storage element 12 is electrically connected to this wiring. That is to say, the power storage element 12 is directly placed on and attached to the outer surface portion (outer wall surface) of the housing 10B. Also, as another form in which the power storage element 12 is held on the housing 10B, for example, the power storage element 12 may be mounted on an electric board separate from the outer surface portion of the housing 10B, and may be attached to the housing 10B in a state in which the electric board is held by the mounting part 10C of the housing 10B. That is to say, a configuration is also possible in which the power storage element 12 is indirectly fixed to an outer flat portion of the outer surface portion of the housing 10B via another member (electric board). Specifically, the power storage element 12 may be directly placed on and fixed to an outer plate surface (outer wall surface) of a plate-shaped wall portion (plate-shaped portion) of the housing 10B.

The charge and discharge circuit unit 30 is provided on the housing 10B. The charge and discharge circuit unit 30 includes the charge circuit 30A and the discharge circuit 30B. The charge circuit 30A is supplied with power from the main power supply 50 via the power path wire 11B (some of the wires 11A) electrically connected to the input path 70 to which the main power supply 50 is connected, and performs a charge operation of charging the power storage element 12 on the basis of this power. That is to say, the power storage element 12 is charged with power supplied via the power path wire 11B, which constitutes the wiring part 11. Also, the discharge circuit 30B performs a discharge operation of allowing the power storage element 12 to discharge via a power path terminal 11D. The power path terminal 11D is constituted by at least one of the plurality of terminals 11C.

The charge circuit 30A is configured as a well-known charge circuit such as a DC/DC converter, and performs a charge operation on the basis of power from the main power supply 50 to supply the power to the power storage element 12 via the charge and discharge path 30C. The charge circuit 30A is configured to be able to receive a charge signal and a charge stop signal from the control circuit 13. If a charge signal is given from the control circuit 13 (if a charge instruction is given), the charge circuit 30A is configured to perform a charge operation of applying a predetermined voltage to the charge and discharge path 30C, and if a charge stop signal is given from the control circuit 13 (if a charge stop instruction is given), the charge circuit 30A is configured to stop the output to the charge and discharge path 30C.

The discharge circuit 30B is configured to switch a portion between the output path (charge and discharge path 30C) from the charge circuit 30A and the power path terminal 11D to a current-flow state or a non-current-flow state. The power path terminal 11D is electrically connected to the discharge circuit 30B. Specifically, a counterpart terminal electrically connected to the load 51 is provided in the connection-receiving part 51A. Also, when the connection part 10A is connected to the connection-receiving part 51A, the power path terminal 11D is connected to the counterpart terminal, and electrically connected to the load 51 via this counterpart terminal. As a result of the connection part 10A being connected to the connection-receiving part 51A, the other end of the power path terminal 11D is electrically connected to the power path 71 of the load 51. The discharge circuit 30B may be configured by, for example, a switching element (such as a MOSFET) that is interposed between the charge and discharge path 30C and the power path terminal 11D, or the like, or may be configured by a DC/DC converter or the like.

If a discharge enable signal is given from the control circuit 13 (if a discharge instruction is given), the discharge circuit 30B performs a discharge operation, and causes the power storage element 12 to discharge power to the load 51. Also, if a discharge stop signal is given from the control circuit 13 (if a discharge stop instruction is given), the discharge circuit 30B stops the discharge operation, and disconnects the charge and discharge path 30C from the power path terminal 11D. Thus, the power path terminal 11D is configured as a power supply path used when the power storage element 12 discharges to the load 51, and the power storage element 12 discharges to the load 51 via the power path terminal 11D when a later-described backup operation or the like is performed.

The charge and discharge circuit unit 30 (the charge circuit 30A and the discharge circuit 30B) forms wiring on the outer peripheral surface of the housing 10B for example, and the charge circuit 30A and the discharge circuit 30B are attached to the housing 10B so that terminals of the elements constituting the charge circuit 30A and the discharge circuit 30B are electrically connected to the wiring. Also, as another form in which the charge and discharge circuit unit 30 (the charge circuit 30A and the discharge circuit 30B) is held on the housing 10B, for example, the charge and discharge circuit unit 30 may be mounted on an electric board, and may be attached to the housing 10B while being held by the housing 10B.

The control circuit 13 is mainly constituted by, for example, a microcomputer, and includes an arithmetic device such as a CPU (Central Processing Unit), a memory such as a ROM (Read Only Memory) or a RAM (Random Access Memory), an A/D converter, and the like. The control circuit 13 is configured to detect a voltage value of the power path wire 11B, and a voltage value of the conductive path connected to the power path terminal 11D, using a not-shown voltage detection circuit or the like. The voltage detection circuit is configured as a well-known voltage detection circuit. The voltage detection circuit is attached to the housing 10B while being held by the housing 10B together with, for example, the control circuit 13 (not shown in FIG. 2). The control circuit 13 functions to control a charge operation and a discharge operation that are performed by the charge and discharge circuit unit 30. Specifically, the control circuit 13 has a function to give a charge signal or a charge stop signal to the charge circuit 30A, and a function to give a discharge signal or a discharge stop signal to the discharge circuit 30B. The control circuit 13 performs control on the charge operation in which the charge circuit 30A charges the power storage element 12, and on the discharge operation in which the discharge circuit 30B allows the power storage element 12 to discharge.

For example, the control circuit 13 controls the operation of the discharge circuit 30B so that power is supplied from the power storage element 12 to the load 51 via the power path terminal 11D after a condition for a backup operation is satisfied. The condition for a backup operation may be such that, for example, the voltage of the input path 70 electrically connected to the main power supply 50 is reduced to a predetermined threshold voltage or lower, or another condition may also be used.

As shown in FIG. 3, the connection part 10A of the connector 10 having such configurations is connected to the connection-receiving part 51A provided on the load 51 side. Specifically, as a result of the lock part 10E provided on the connection part 10A locking to the lock-receiving part (not shown) formed on the connection-receiving part 51A, the connector 10 is maintained in a state in which the power path terminal 11D and the power path 71 are electrically connected to each other.

If due to a defect or the like of the load 51, the load 51 needs to be replaced, first, the lock part 10E of the connector 10 and the lock-receiving part of the connection-receiving part 51A are brought into a state in which they are no longer locked to each other, and the connection part 10A is removed from the connection-receiving part 51A. At this time, the power storage element 12 is removed from the connection-receiving part 51A together with the wiring part 11 and the connection part 10A. Then, the broken load 51, the power path 71, and the connection-receiving part 51A are removed from the vehicle, and a new load 51, a new power path 71, and a new connection-receiving part 51A are attached to the vehicle. Then, by locking the lock part 10E of the connection part 10A to the lock-receiving part of the connection-receiving part 51A, a state is realized in which the power path terminal 11D and the power path 71 are electrically connected to each other.

Examples of the effects of the present configuration will be given below.

The connector 10 of the present disclosure includes: the housing 10B; the wiring part 11 that includes the plurality of wires 11A and the plurality of terminals 11C, one end of the wiring part 11 being held by the housing 10B and drawn out from the housing 10B; and the power storage element 12 attached to the housing 10B while being held by the housing 10B. Also, the power storage element 12 is configured to be charged with power supplied via the wiring part 11, and discharge via the wiring part 11.

Since the connector 10 can have a configuration in which the housing 10B and the power storage element 12 are formed as one piece in such a manner that the power storage element 12 is held by the housing 10B, it is possible to omit a structure dedicated to holding the power storage element 12, and to simplify the physical connection between a connector-related component such as the housing 10B or the wiring part 11, and the power storage element 12. Moreover, since the power storage element 12 held by the housing 10B can perform charging and discharging via the wiring part 11 incorporated in the housing 10B, it is possible to omit the wiring extending from the power storage element 12 to the connector 10. Accordingly, it is also possible to simplify the electrical connection between the connector-related component and the power storage element 12.

The connector 10 according to the present disclosure includes the discharge circuit 30B that performs a discharge operation of allowing the power storage element 12 to discharge, and the control circuit 13 that controls the discharge operation of the discharge circuit 30B.

With this configuration, it is possible to simplify not only the physical connection and the electrical connection between the connector-related component and the power storage element 12, but also the physical connection for holding the discharge circuit 30B and the control circuit 13 and the electrical connection between these circuits, the connector-related component, and the power storage element 12.

In the connector 10 of the present disclosure, the terminals 11C, which constitute the wiring part 11, are configured as a power supply path to a load to be backed up. The power storage element 12 is configured to be able to discharge to the load 51 via this power supply path.

With this configuration, it is possible to realize a configuration in which the power storage element 12 can be used as a backup power supply with simplified electrical connection and physical connection. Specifically, wiring or the like connected to the power supply path extending from the power storage element 12 to the load 51 can be omitted or simplified.

Also, since the power storage element 12 is formed as one piece with the connector 10, the power storage element 12 can be a general-purpose backup power supply that can cover various types of loads.

In the connector 10 of the present disclosure, the wiring part 11 includes at least one wire 11A whose end on one side is held by the housing 10B and that is drawn out from the housing 10B. The power storage element 12 is fixed to the outer surface portion of the housing 10B, and the power storage element 12, the housing 10B, and the wire 11A are formed as one piece. The housing 10B is capable of being detachably attached to the connection-receiving part 51A, which constitutes a power path located on the load 51 side relative to the housing 10B.

With this configuration, it is possible to remove the connector 10 in which the power storage element 12, the housing 10B, and the wire 11A are formed as one piece from the configuration on the load 51 side from the connection-receiving part 51A, which is advantageous in terms of maintenance and the like. For example, if a part on the load 51 side is broken and is to be replaced for example, the connector 10 including the power storage element 12 does not need to be replaced.

### Embodiment 2

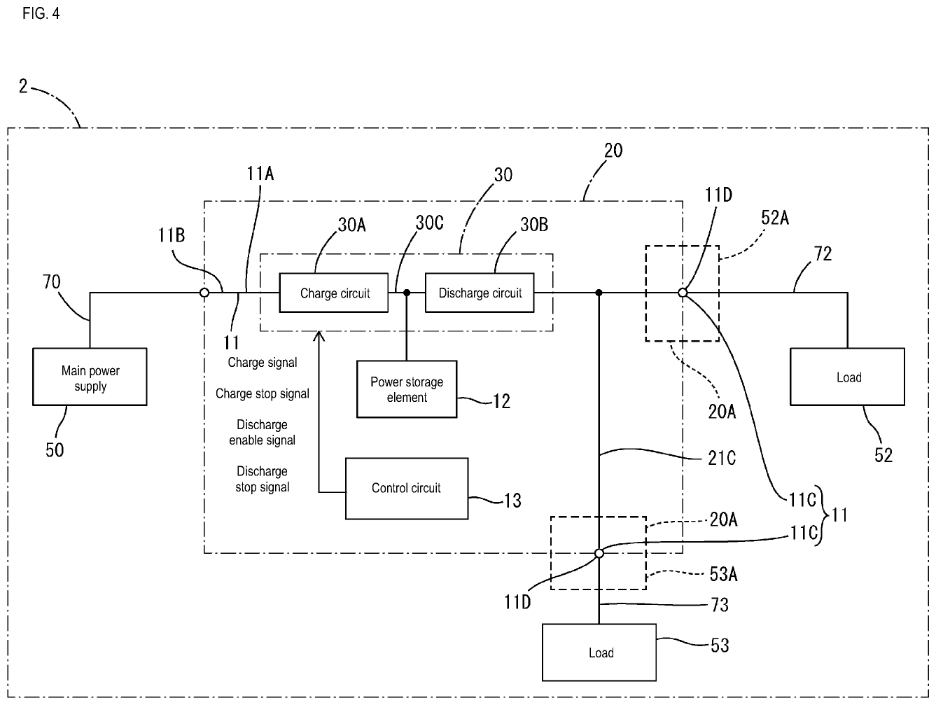

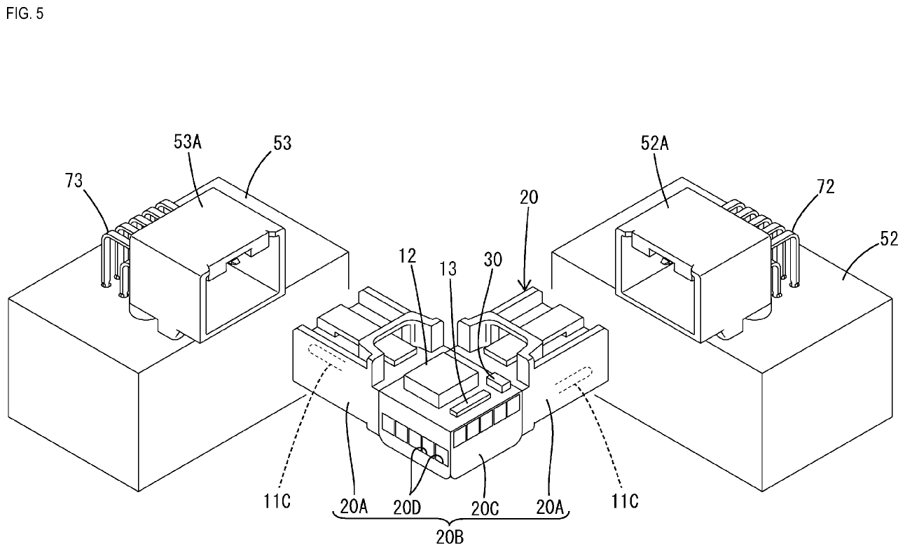

The following will describe a connector 20 according to Embodiment 2 with reference to FIGS. 4 and 5. The connector 20 differs from Embodiment 1 for example in that two connection parts 20A of a housing 20B are provided. Other configurations are the same as those in Embodiment 1, and thus the same reference numerals are given to the same configurations, and descriptions on their structures, functions, and effects are omitted.

As shown in FIGS. 4 and 5, the connector 20 according to Embodiment 2 is used in a power supply system 2 shown in FIG. 4, and the housing 20B is provided with two connection parts 20A, for example. Note that in FIG. 4, a path (main power path) through which power is supplied to loads 52 and 53 from the main power supply 50 without the intermediary of the charge and discharge circuit unit 30 is omitted. The connection parts 20A extend in different directions and are coupled to the mounting part 20C (see FIG. 5). A wiring part 11 of the connector 20 includes a plurality of wires 11A and a plurality of terminals 11C. In FIG. 4, only a subset of the plurality of wires 11A is shown, and in FIG. 5, illustration of the wires 11A is omitted. Also, in FIG. 5, only some of the terminals 11C are shown as examples. Note that the wires 11A may be drawn out from the housing 20B in any fashion.

Ends of some of the terminals 11C (two power path terminals 11D) on one side are electrically connected to the discharge circuit 30B. The two power path terminals 11D are respectively provided on the connection parts 20A. Connection-receiving parts 52A and 53A of the respective loads 52 and 53 are connected to the respective connection parts 20A of the connector 20. A power path 72 through which power is supplied from the main power supply 50 or the power storage element 12 of the connector 20 is electrically connected to the load 52. The power path 72 is provided with the connection-receiving part 52A to and from which one of the connection parts 20A of the connector 20 can be attached and detached. A power path 73 through which power is supplied from the main power supply 50 or the power storage element 12 is electrically connected to the load 53. The power path 73 is provided with the connection-receiving part 53A to and from which the other connection part 20A of the connector 20 can be attached and detached. That is to say, the connector 20 includes the plurality of connection parts 20A that can be attached to and detached from the connection-receiving parts 52A and 53A provided on the respective power paths 72 and 73 through which power is supplied to the plurality of loads 52 and 53, and the plurality of connection parts 20A are branches that respectively correspond to the plurality of connection-receiving parts 52A and 53A.

Specifically, the connection-receiving part 52A includes a counterpart terminal that is electrically connected to the load 52. When one of the connection parts 20A is connected to the connection-receiving part 52A, the power path terminal 11D (constituted by at least one of the terminals 11C) provided on this connection part 20A is connected to the counterpart terminal of the connection-receiving part 52A, and is electrically connected to the load 52 via this counterpart terminal. Similarly, the connection-receiving part 53A includes a counterpart terminal that is electrically connected to the load 53. When the other connection part 20A is connected to the connection-receiving part 53A, the power path terminal 11D (constituted by at least one of the terminals 11C) provided on this connection part 20A is connected to the counterpart terminal of the connection-receiving part 53A, and is electrically connected to the load 53 via this counterpart terminal.

The mounting part 20C has a plurality of insertion holes 20D on surfaces opposite to the surfaces on which the connection parts 20A are provided. A terminal fitting connected to an end of a wire 11A on one side is inserted into each of the insertion holes 20D, and the terminal fitting is held by the housing 20B (not shown).

Examples of the effects of the present configuration will be given below.

The connector 20 of the present disclosure has a configuration in which the housing 20B includes the plurality of connection parts 20A, and the connection parts 20A are configured to be detachably connected respectively to the plurality of connection-receiving parts 52A and 53A that constitute power paths to the plurality of loads 52 and 53. The power storage element 12 is configured to discharge to the respective loads 52 and 53 via the wiring parts 11 provided on the connection parts 20A.

With this configuration, it is possible to simplify all of the configurations (such as the wiring) provided in the range from the power storage element 12 to the power paths (power paths through which power is supplied to the loads), and thus the effect of simplifying the electrical connection and the physical connection can be further improved.

### Other Embodiments

The present configuration is not limited to the embodiments described with reference to the specification given above and the drawings, and the following embodiments are included in the technical scope of the present invention.

Although Embodiment 1 has exemplified a structure in which the power storage element 12 is directly or indirectly attached to the outer surface portion of the housing 10B, the power storage element may be attached to the inner surface portion of the housing. Specifically, a configuration is also possible in which an accommodation part for accommodating the power storage element is provided in the housing, the power storage element is put in this accommodation part, a plate-shaped cap is provided as a constituent component of the housing, and the power storage element is covered by the cap.

Although Embodiments 1 and 2 disclose a configuration in which the power storage element 12 is charged via the power path wire 11B, and discharges via the power path terminal 11D, it is also possible to adopt a configuration in which the power storage element is charged via the power path terminal and discharges via the power path wire, or a configuration in which the power storage element is charged via the power path wire, and discharges via the power path wire.

Although Embodiment 1 has exemplified a configuration in which the control circuit 13, the charge circuit 30A, and the discharge circuit 30B are attached to the connector 10, it is also possible to adopt a configuration in which none of the control circuit, the charge circuit, and the discharge circuit are attached to the connector, or a configuration in which any one or more of them is attached to the connector. Specifically, by mounting the control circuit, the charge circuit, and the discharge circuit on an electric board, attaching this electric board to any component of the vehicle other than the connector, and electrically connecting the electric board to some of the wires of the wiring part, the charge operation and discharge operation of the power storage element of the connector may be controlled.

Although in Embodiment 1, the control circuit 13 is mainly constituted by a microcomputer, the control circuit 13 may also be realized by a plurality of hardware circuits, instead of the microcomputer.

In Embodiment 2, two connection parts 20A are provided, but the number of the connection parts may also be three or more.

The embodiments disclosed herein are examples in all respects, and should be construed as non-limiting. The scope of the present invention is not limited to the embodiments disclosed herein, but is indicated by the claims, and is intended to include all modifications within the meaning and scope equivalent to the scope of the claims.

1. A connector comprising:
a housing;
a wiring part that includes at least one wire and at least one terminal, one end of the wiring part being held by the housing; and
a power storage element attached to the housing while being held by the housing,
wherein the power storage element is configured to be charged with power supplied via the wiring part, and discharge via the wiring part.

2. The connector according to claim 1, comprising:
a discharge circuit configured to perform a discharge operation of allowing the power storage element to discharge; and
a control circuit configured to control the discharge operation of the discharge circuit.

3. The connector according to claim 1, wherein at least part of the wire or the terminal of the wiring part is configured as part of a power supply path to a load to be backed up, and
the power storage element is configured to discharge to the load via the power supply path.

4. The connector according to claim 3, wherein the housing includes a plurality of connection parts,
the plurality of connection parts are configured to be detachably connected respectively to a plurality of connection-receiving parts that constitute power paths to a plurality of the loads, and
the power storage element is configured to discharge to each of the loads via the wiring part provided on the corresponding connection part.

5. The connector according to claim 3, wherein the wiring part includes at least one wire whose end on one side is held by the housing and that is drawn out from the housing,
the power storage element is fixed to an outer surface portion or an inner surface portion of the housing,
the power storage element, the housing, and the wire are formed as one piece, and
the housing is capable of being detachably attached to a counterpart connector that constitutes a power path located on the load side relative to the housing.

6. The connector according to claim 2, wherein at least part of the wire or the terminal of the wiring part is configured as part of a power supply path to a load to be backed up, and
the power storage element is configured to discharge to the load via the power supply path.

7. The connector according to claim 4, wherein the wiring part includes at least one wire whose end on one side is held by the housing and that is drawn out from the housing,
the power storage element is fixed to an outer surface portion or an inner surface portion of the housing,
the power storage element, the housing, and the wire are formed as one piece, and
the housing is capable of being detachably attached to a counterpart connector that constitutes a power path located on the load side relative to the housing.
